(19) United States
(12) Patent Application Publication
(10) Pub. No.: US 2013/0085918 A1
(43) Pub. Date: Apr. 4, 2013

(54) ELECTRONIC WALLET

(71) Applicant: JIAN-HUI LI, Shenzhen City (CN)

(72) Inventor: JIAN-HUI LI, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/596,258

(22) Filed: Aug. 28, 2012

(30) Foreign Application Priority Data
Sep. 30, 2011 (CN) 201110291770.2

(51) Int. Cl. G06Q 40/00

(52) U.S. Cl. 705/35

(57) ABSTRACT

An electronic wallet for accessing a credit card account information includes a card reader, a processor, a touch screen, a radio frequency (RF) module, and an antenna. The card reader, the touch screen, and the RF module are electrically connected to processor. The card reader is adapted to read card number and correlation information of the credit card. The processor receives the card number and correlation information from the card reader to identify the credit card issuer, and sends a control signal to the touch screen to display a login interface of the identified credit card issuer. The touch screen allows users to input the card number and password on the login interface. The processor encrypts the card number and the password. The RF module converts an encrypted signal received from the processor to RF signals, and sends the RF signals to networks through the antenna.

### BACKGROUND

1. Technical Field

The disclosure generally relates to electronic wallets, and particularly to an electronic wallet based on wireless communications.

2. Description of the Related Art

Typically, a person has a plurality of credit cards to pay for goods and services. However, the person needs to log into his account on each website for each credit card or call each credit card issuer to access his credit cards account information on his computer or smart phone. This can be time consuming and a hassle.

Therefore, there is room for improvement within the art.

### BRIEF DESCRIPTION OF THE DRAWINGS

Many aspects of an exemplary electronic wallet can be better understood with reference to the following drawings. The components in the drawings are not necessarily drawn to scale, the emphasis instead being placed upon clearly illustrating the principles of the exemplary electronic wallet. Moreover, in the drawings, like reference numerals designate corresponding parts throughout the several views. Wherever possible, the same reference numbers are used throughout the drawings to refer to the same or like elements of an embodiment.

FIG. 1 is a schematic diagram of an electronic wallet, according to an exemplary embodiment.

FIG. 2 is a block diagram of the electronic wallet shown in FIG. 1.

### DETAILED DESCRIPTION

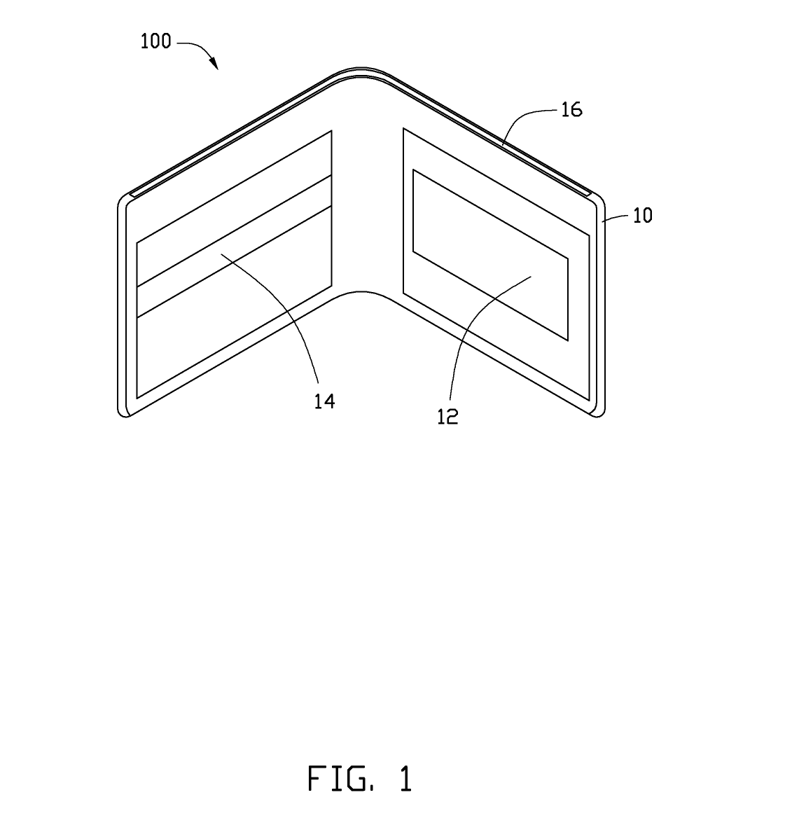

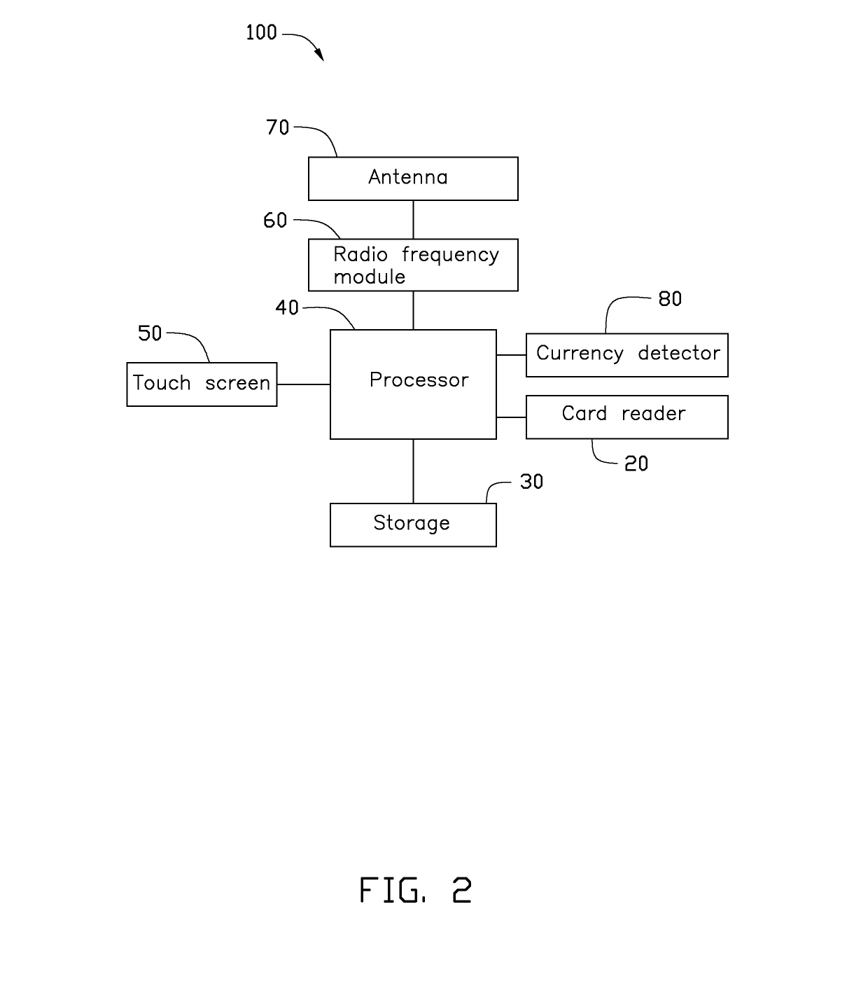

Referring to FIG. 1 and FIG. 2, according to an exemplary embodiment, an electronic wallet 100 for assessing credit card account information includes a main body 10, a card reader 20, a storage 30, a processor 40, a touch screen 50, a radio frequency (RF) module 60, an antenna 70, and a currency detector 80. The processor 40 is electrically connected to the card reader 20, the storage 30, the touch screen 50, and the RF module 60.

The main body 10 includes an inner layer 12, an interlayer 14 opposite to the inner layer 12, and an outer layer 16. The inner layer 12 and the interlayer 14 are located at a same side of the outer layer 16. In the exemplary embodiment, the touch screen 50 is located on the inner layer 12. The card reader 20 is located in the interlayer 14, and the currency detector 80 is located on an edge of the outer layer 16. The storage 30, the processor 40, the RF module 60 and the antenna 70 are integrated on a printed circuit board (not shown), and the printed circuit board is located in the main body 10.

The card reader 20 is capable of reading both magnetic strip cards and smart cards which have either or both magnetic strips and integrated circuits (smartcard chips). The card reader 20 is adapted to read at least card number and correlation information of credit cards. Generally, first six numerals of the card number identify the card issuer of the credit card. The correlation information of the credit cards may include information of the credit card issuers, such as if the first six numerals of the card number are 402817, the credit card issuer is Citi Bank; if the first six numerals of the card number are 413384, the credit card issuer is Commerce Bank.

The storage 30 stores credit cards information which includes at least card numbers and login interfaces of credit card issuers. Each card number corresponds to a unique credit card issuer. The login interfaces of credit card issuers for login include at least a card number field and a password field. User can input card number and password of his credit card through the login interface to access the credit card account information.

The RF module 60 is electrically connected to the antenna 70. The antenna 70 communicates wirelessly with networks and receives feedback information from a system manager terminal of the credit card issuers through the networks. The system manager terminal stores account information of credit cards and cardholder identification information such as identification number, password of credit card and so on. The feedback information includes at least cardholder's name, and account information of the credit card.

The currency detector 80 is adapted to determine whether bills or coins are genuine or counterfeit. The principle of the currency detector 80 involves examining the bill or the coin that has been inserted, and by using various tests (for example, magnetic analysis, fluorescent sense, coin evaluation based on its weight, size, and/or magnetism), determining if the bill or the coin is counterfeit. If the bill or the coin is counterfeit, the currency detector 80 sounds a warning to remind users. In the exemplary embodiment, the currency detector 80 is electrically connected to the processor 40, and sends a determining result to the processor 40.

The working processes of the electronic wallet 100 may include the following steps:

If a user want to access a credit card account information, the credit card is put into the interlayer 14 and the card reader 20 reads card number and correlation information of the credit card. The card reader 20 sends the card number and the correlation information to the processor 40. The processor 40 receives the card number and correlation information from the card reader 20, reads credit cards information from the storage 30, and compares the card number with the credit cards information to identify a login interface of the credit card issuer. The processor 40 sends a control signal to the touch screen 50, the touch screen 50 displays the login interface of the credit card issuer according to the control signal. The user can input the card number and password on the login interface through the touch screen 50. The processor 40 encrypts the card number and the password, and sends an encrypted signal to the RF module 60.

The RF module 60 converts the encrypted signal to RF signals, and sends the RF signals to the networks through the antenna 70. The system manager terminal of the credit card issuer receives the RF signals from the networks, and determines whether the password is validated. If the password is validated, the system manager terminal sends a feedback signal containing the credit card account information to the antenna 70 through the networks. The RF module 60 receives the feedback signal from the antenna 70, and sends the feedback signal to the processor 40.

The processor 40 sends the feedback signal to the storage 30 and the touch screen 50. According to the feedback signal, the storage 30 stores the credit card account information, and the touch screen 50 displays the credit card account information.

The card reader 20 can read card number and correlation information of the credit cards, and the processor 40 encrypts the card number and the password, and the encrypted signal is sent to the system manager terminal of the credit card issuer through the antenna 70. The system manager terminal sends a feedback signal containing the credit card account information to the antenna 70. Thus, user can access their credit card account information through the electronic wallet 100 directly.

In another exemplary embodiment, the currency detector 80 works independently without electronic connections.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. An electronic wallet for accessing a credit card account information from a system manager terminal of a credit card issuer, comprising:
a card reader for reading card number and correlation information of the credit card;
a processor electrically connected to the card reader;
a touch screen electrically connected to the processor;
a radio frequency (RF) module electrically connected to the processor; and
an antenna electrically connected to the RF module;
wherein the processor receives the card number and correlation information from the card reader to identify the credit card issuer, and sends a control signal to the touch screen to display a login interface of the identified credit card issuer; the touch screen allows users to input the card number and password on the login interface; the processor encrypts the card number and the password, and sends an encrypted signal to the RF module; the RF module converts the encrypted signal to RF signals, and sends the RF signals to the system manager terminal through the antenna; the antenna receives a feedback information from the system manager terminal.

2. The electronic wallet as claimed in claim 1, wherein the electronic wallet further comprises a storage electrically connected to the processor, the storage stores credit cards information which includes at least card numbers and the login interfaces of credit cards issuers.

3. The electronic wallet as claimed in claim 2, wherein the processor reads the credit cards information from the storage, and compares the card number with the credit cards information to identify a login interface of the credit card issuer.

4. The electronic wallet as claimed in claim 3, wherein the RF signals are received by a system manager terminal of the credit card issuer though the networks, and the password is validated by the system manager terminal.

5. The electronic wallet as claimed in claim 4, wherein if the password is validated, the feedback signal containing the credit card account information is sent to the antenna by the system manager terminal.

6. The electronic wallet as claimed in claim 5, wherein the RF module receives the feedback signal from the antenna, and sends the feedback signal to the processor.

7. The electronic wallet as claimed in claim 6, wherein the processor sends the feedback signal to the storage and the touch screen, according to the feedback signal, the storage stores the credit card account information, and the touch screen displays the credit card account information.

8. The electronic wallet as claimed in claim 2, wherein the electronic wallet further comprise a main body, the main body comprises an inner layer, an interlayer opposite to the inner layer, and an outer layer, the inner layer and the interlayer are located at a same side of the outer layer.

9. The electronic wallet as claimed in claim 8, wherein the touch screen is located on the inner layer, the card reader is located in the interlayer.

10. The electronic wallet as claimed in claim 9, wherein the storage, the processor, the RF module and the antenna are integrated on a printed circuit board, and the printed circuit board is located in the main body.

11. The electronic wallet as claimed in claim 10, wherein the electronic wallet further comprises a currency detector adapted to determine whether bills or coins are genuine or counterfeit, the currency detector is located on an edge of the outer layer.

12. The electronic wallet as claimed in claim 11, wherein the currency detector is electrically connected to the processor, and sends a determining result to the processor.

13. The electronic wallet as claimed in claim 11, wherein if the bill or the coin is counterfeit, the currency detector sounds a warning to remind users.

14. An electronic wallet for accessing a credit card account information a system manager terminal of a credit card issuer, comprising:
a main body comprising an inner layer, an interlayer opposite to the inner layer, and an outer layer, the inner layer and the interlayer located at a same side of the outer layer;
a card reader for reading card number and correlation information of the credit card located in the interlayer;
a processor electrically connected to the card reader;
a touch screen electrically connected to the processor located on the inner layer;
a radio frequency (RF) module electrically connected to the processor;
an antenna electrically connected to the RF module; and
a currency detector adapted to determine whether bills or coins are genuine or counterfeit, the currency detector located on an edge of the outer layer;
wherein the processor receives the card number and correlation information from the card reader to identify the credit card issuer, and sends a control signal to the touch screen to display a login interface of the identified credit card issuer; the touch screen allows users to input the card number and password on the login interface; the processor encrypts the card number and the password, and sends an encrypted signal and password to the RF module; the RF module converts the encrypted signal to RF signals, and sends the RF signals to the system manager terminal through the antenna; the antenna receives a feedback information from the system manager terminal.

15. The electronic wallet as claimed in claim 14, wherein the electronic wallet further comprises a storage electrically connected to the processor, the storage stores credit cards information which includes at least card numbers and the login interfaces of credit cards issuers.

16. The electronic wallet as claimed in claim 15, wherein the processor reads the credit cards information from the storage, and compares the card number with the credit cards information to identify a login interface of the credit card issue.

17. The electronic wallet as claimed in claim 16, wherein the RF signals are received by a system manager terminal of the credit card issuer though the networks, and the password is validated by the system manager terminal.

18. The electronic wallet as claimed in claim 17, wherein if the password is validated, the feedback signal containing the credit card account information is sent to the antenna by the system manager terminal.

19. The electronic wallet as claimed in claim 18, wherein the RF module receives the feedback signal from the antenna, and sends the feedback signal to the processor.

20. The electronic wallet as claimed in claim 19, wherein the processor sends the feedback signal to the storage and the touch screen, according to the feedback signal, the storage stores the credit card account information, and the touch screen displays the credit card account information.
